(19) United States
(12) Patent Application Publication
(10) Pub. No.: US 2022/0396479 A1
(43) Pub. Date: Dec. 15, 2022

(54) METHOD FOR PYROLYTIC DECOMPOSITION OF GASEOUS HYDROCARBONS AND APPARATUS FOR PERFORMING THE SAME

(71) Applicant: Yury Fedorovich YURCHENKO, Altai Territory (RU)

(72) Inventor: Yury Fedorovich YURCHENKO, Altai Territory (RU)

(21) Appl. No.: 17/577,625

(22) Filed: Jan. 18, 2022

(30) Foreign Application Priority Data
Jun. 9, 2021 (RU) 2021116812

(51) Int. Cl. C01B 3/28; C01B 3/50; C09C 1/48; B01J 8/08; B01J 8/10; B01J 8/00

(52) U.S. Cl. CPC C01B 3/28; C01B 3/501; C09C 1/487; B01J 8/085; B01J 8/087; B01J 8/10; B01J 8/0085; B01J 8/0055; B01J 8/006; B01J 8/009; C01B 2203/0255; C01B 2203/0272; C01B 2203/0405; C01B 2203/1241; C01B 2203/1247; C01B 2203/1258; C01B 2203/0816; C01B 2203/0822; C01B 2203/0827; B01J 2208/00761; B01J 2208/00867; B01J 2208/00902

(57) ABSTRACT

The invention relates to the chemical industry and can be used for processing methane and other volatile, liquid, solid fusible hydrocarbons when producing hydrogen, soot, and other flammable gases. The invention relates to a method for the pyrolytic decomposition of hydrocarbons, in which a pyrolysis reactor arranged in a space bounded by a lining is heated by flue gases generated by combusting a hydrogen-enriched mixture of air and gaseous hydrocarbons, while ensuring a maximum decrease in CO₂ emissions into the atmosphere. The invention also relates to a unit for the pyrolytic decomposition of hydrocarbons. The technical result is a high degree of separation of hydrogen and carbon by fast high-temperature pyrolysis at atmospheric pressure without oxygen supply and without CO₂ production.

### CROSS-REFERENCE TO RELATED APPLICATION

This patent application claims priority to Russian patent application RU2021116812 filed Jun. 9, 2021, all of which is incorporated by reference in its entirety.

### TECHNICAL FIELD OF THE INVENTION

The invention relates to the chemical industry and can be used for processing methane and other volatile, liquid, solid fusible hydrocarbons when producing hydrogen, soot, and other flammable gases.

### BACKGROUND OF THE INVENTION

The technical solution closest to the invention is described in the application for the grant of a patent of the Russian Federation for invention No. 2020134076, dated 16 Oct. 2020.

The known technical solution uses a heat exchanger, the outer space of which is used to supply flue gases intended for heating a raw material entering the inner space of the heat exchanger. The inner space of the heat exchanger, which is intended for supplying the raw material, comprises a stirrer configured as blades arranged on a rotating shaft. The known technical solution has a high efficiency when it is used for the pyrolysis of solid hydrocarbons. However, the processing of gaseous and liquid hydrocarbons is impossible due to the small area of heat exchange in the inner space of the heat exchanger and the lack of the possibility of removing soot from a reactor.

### SUMMARY OF THE INVENTION

The technical problem solved by the present invention is to develop a technology that ensures the maximum extraction of hydrogen from a supplied raw material, provided that evolved carbon is converted into soot and removed from a reactor.

The technical result provided by using the present invention is an achievable high degree of separation of hydrogen and carbon by fast high-temperature pyrolysis at atmospheric pressure without oxygen supply and without CO₂ production. At the same time, an increase in the efficiency of pyrolytic decomposition of gaseous hydrocarbons is achieved, while reducing thermal pollution and carbon dioxide emissions into the atmosphere.

The technical result is achieved due to the fact that in a method for the pyrolytic decomposition of hydrocarbons, a pyrolysis reactor arranged in a space bounded by a lining is heated by flue gases generated by combusting a hydrogen-enriched mixture of air and gaseous hydrocarbons, while ensuring a maximum decrease in CO₂ emissions into the atmosphere. The flue gases are moved vertically downward in the space between the lining and the reactor. Heated hydrocarbons are supplied to a lower part of the reactor, and hydrogen and soot generated by the pyrolytic decomposition are removed from an upper part of the reactor. A heat transfer of the reactor from the flue gases to pyrolysis products is increased using heat-conducting metal elements piercing through walls of the reactor. A main ablation surface is formed by filling the inner space of the reactor with ceramic balls inert to the gaseous hydrocarbons and products of their pyrolytic decomposition. The heat-conducting elements and inner walls of the reactor are cleaned from the soot due to multidirectional movements of the ceramic balls, by using blades fixed on a rotating shaft such that the ceramic balls move upward at a peripheral shell of the reactor and downward in a central part of the reactor near the rotating shaft. In this case, natural gases, such as methane, associated gases, may be used as the hydrocarbons. Furthermore, liquid heated hydrocarbons, fuel oil, waste oils, oil sludge, which are supplied under pressure through nozzles installed in the lower part of the reactor, may be used as the hydrocarbons. Solid fusible hydrocarbons, such as plastic waste, which is converted into liquid hydrocarbons by means of melting, may be used as the hydrocarbons. In a particular embodiment, the mixture of air and hydrocarbon gas which is enriched with hydrogen obtained by the pyrolytic decomposition of the hydrocarbons is used to heat the reactor. When implementing the method, the flue gases in the space between the lining and the reactor are moved from top to bottom, while providing a temperature in the upper part of the reactor in the range from 950° C. to 1150° C. and in the lower part of the reactor in the range from 750° C. to 950° C. and ensuring a chain reaction of carbon evolution. The hydrocarbons are supplied to the reactor from bottom to top as a counter-flow to the flue gases, thereby ensuring uniform heating. Before being supplied to the reactor, the liquid and gaseous hydrocarbons are heated to a temperature of 390° C. to 410° C., and the fusible hydrocarbons are heated to a temperature of 300° C. to 320° C.

To ensure the occurrence and course of the chain reaction of carbon evolution from the hydrocarbons in the reactor, conditions are provided, under which the gas temperature rises at a rate of up to 300° C. in 0.1 sec. A flow rate of hydrocarbon gases in the reactor is maintained such that the heating temperature of a gas flow in the reactor is maintained in the range from 300° C. to 1050° C. When implementing the method, a mixture of hydrogen with undecomposed hydrocarbon gases is removed from the upper part of the reactor, pure hydrogen is isolated from the mixture using a membrane filter, and one part of the mixture of hydrocarbon gases with hydrogen is directed to a burner to generate the flue gases, while another part of the mixture of hydrocarbon gases with hydrogen is re-directed to the reactor for the pyrolytic decomposition.

The technical result is achieved in an apparatus due to the fact that a unit for the pyrolytic decomposition of hydrocarbons comprises: a housing having a lining; a vertical reactor installed in the housing and having walls provided with heat-conducting elements, the reactor having an inner space filled with ceramic balls inert to gaseous hydrocarbons and products of their pyrolytic decomposition; a vertical shaft having blades and installed in the reactor, the vertical shaft being rotatable, and the blades having a shape that ensures a movement of granules at an angle to a horizontal, wherein:

an inlet manifold for supplying flue gases from a burner to the space between the reactor and the lining is arranged in an upper part of the reactor;

a manifold for removing waste flue gases from the reactor is arranged in a lower part of the reactor;

an inlet for supplying processed hydrocarbons is arranged in the lower part of the reactor;

a manifold for removing pyrolytic decomposition products from the inner space of the reactor is arranged in the upper part of the reactor,

the apparatus comprises a cyclone separator having an inlet connected to the upper manifold of the reactor and an outlet for purified gases connected to plate coolers and a filter-separator, the filter-separator having a gas outlet connected to a pump-compressor, the pump-compressor having an outlet connected to an inlet of a membrane filter, the cyclone separator being configured to separate a mixture of gases into pure hydrogen and a mixture of gases with hydrogen;

the membrane filter has an outlet that is intended for removing the mixture of gases with hydrogen and connected to the burner, the burner having a flue gas outlet connected to the inlet manifold for supplying the flue gases to the reactor; and

the cyclone separator has a conical part connected to a screw conveyor which removes the soot deposited in the conical part into a hopper through a flood gate. When the apparatus is used for the pyrolytic decomposition of gaseous hydrocarbons, the inlet for supplying heated processed gaseous hydrocarbons to the reactor is made as a manifold. When the apparatus is used for the pyrolytic decomposition of liquid hydrocarbons, the inlet for supplying the processed hydrocarbons is made as a nozzle unit. When the apparatus is used for the pyrolytic decomposition of solid fusible hydrocarbons, the apparatus further comprises a unit for melting the solid fusible hydrocarbons which is connected to a pump for supplying the molten hydrocarbons to nozzles. To implement the claimed purpose, the shape of the blades fixed on the rotating shaft causes the ceramic balls to move, thereby cleaning the heat-transfer elements, the walls of the reactor and the balls themselves from the soot deposited thereon. The blades near the shaft and near the walls of the inner space of a heat exchanger are made with an opposite pitch, and the heat-conducting elements may pass through the walls of the reactor such that the same heat-conducting element is in contact with the flue gases in the outer part of the reactor and with the balls and the pyrolysis products in the inner part of the reactor.

### BRIEF DESCRIPTION OF THE DRAWING

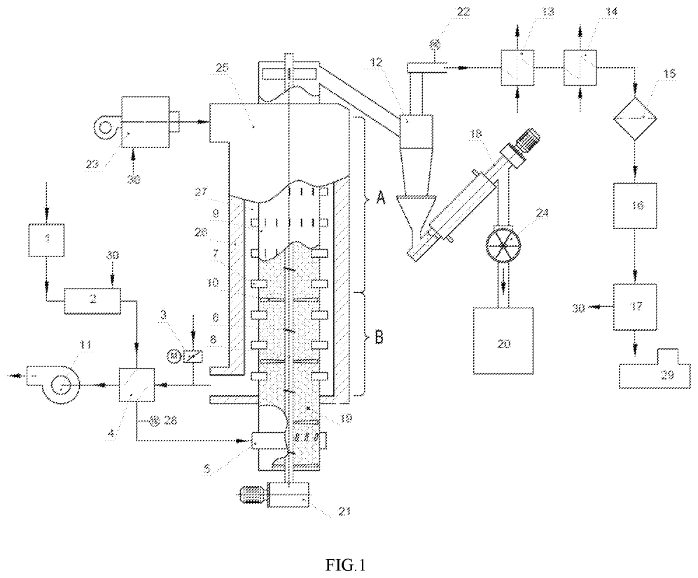

The FIG. 1 shows a pyrolytic (pyrolysis) reactor in which the invention is implemented.

### DETAILED DESCRIPTION OF THE INVENTION

As shown in the FIGURE, a pyrolysis reactor 25 is heated by flushing with a flue gas using a gas burner 23. A temperature in an upper zone A inside the pyrolysis reactor is maintained at a level of 950° C. to 1150° C. to ensure a stable pyrolysis process. At temperatures above 1150° C., the efficiency of the reactor operation decreases, and the destruction of its structural elements is possible. At temperatures below 950° C., the rate of the pyrolysis process decreases. To ensure the uniform and maximum heating and decomposition of processed hydrocarbons, they are supplied to the reactor from the bottom, as a counter-flow to flue gases which are supplied from the top. To efficiently use the entire space of the reactor, the supply rate of the raw materials and the flue gas is controlled such that the temperature of the flue gases at the outlet of the reactor is 700° C.-800° C., since the pyrolysis process proceeds slowly at temperatures below 700° C. and excessive hydrogen and carbon evolution occurs at temperatures above 800° C., which leads to the uneven heating of the gas and a significant decrease in the hydrogen removal. The heating temperature of the reactor directly depends on the reactor dimensions and capacity. The higher the reactor capacity and the larger the reactor dimensions, the higher the temperature to which it should be heated.

The flue gases from the gas burner 23 pass through the outer cavity of the reactor through a channel 27, between a fire-resistant lining 26 and the outer walls of a reactor housing 9 filled with ceramic balls 19 that are inert to gaseous hydrocarbons and products of their pyrolytic decomposition. The flue gases simultaneously heat the lining 26, the reactor housing 9, and pass-through heat-conducting elements 7 which are simultaneously in contact with the flue gases, the ceramic balls, and the gaseous hydrocarbons in the inner space of the reactor.

The temperature of the waste flue gases entering a plate heat exchanger 4 for preheating gaseous hydrocarbons is automatically maintained using an electrically driven damper 3 by diluting the flue gases entering a smoke exhauster 11 in front of the heat exchanger. The temperature of the flue gases is automatically controlled by the damper 3 based on the readings of a temperature sensor 28 that measures the temperature of the gas to be processed.

A main gas from a gas distribution station 1 enters a shut-off and control unit 2, by which all control and limiting actions are performed in respect of the gas to be processed. The gas is supplied from the unit 2 to the plate heat exchanger 4, in which it is heated to a temperature of 350° C. to 450° C., thereby ensuring the maximum use of the heat exchanger space filled with granules.

The preheated gas enters, through an inlet for supplying hydrocarbons and a manifold 5, the lower part of the reactor which is heated to a temperature of 700° C. to 800° C. After that, it comes into contact with the ceramic balls and the soot released from the gas during the pyrolysis process and moving downward in the process of mixing the ceramic balls with blades. Furthermore, the gas is in contact with the walls of the reactor housing 9 and the internal heat-conducting elements 7 of the reactor, for which reason the gas is rapidly heated in a zone B to 600° C.-700° C. and partially decomposes into hydrogen and carbon-contained vapors. The design of the blades fixed on a shaft 8 provides the multidirectional movement of the ceramic balls relative to the horizontal at different distances from a shaft axis. For example, the angle of the blades relative to the horizontal near the shaft allows the balls to move downward, and the angle of the blades in the peripheral zone of the inner space of the reactor allows the balls to move upward. When moving in the vertical direction, the balls capture the particles of the released soot and evenly distribute them over the inner space of the reactor, and the inevitable movement of the balls in the horizontal direction ensures their contact with heat-conducting ribs and, accordingly, ensures the uniform heating of the inner space of the reactor. The soot acts as a catalyst and carbon evolution centers throughout the space of the reactor, and the excess soot is separated from the inner surfaces of the reactor and the ceramic balls during the interaction of the balls with each other and removed from the reactor under the action of a directed flow of gaseous pyrolysis products.

As the hydrocarbons, liquid hydrocarbons may also be used, which are supplied to the lower part of the reactor 5 through nozzles not shown in the FIGURE.

In a particular embodiment, short spiral vanes or blades 6 arranged next to the shaft move the ceramic balls down the reactor, with the balls entraining a part of the soot which acts as a catalyst or carbon evolution centers and initiates pyrolytic reactions already in the lower part of the reactor. Long blades 10 move the balls upward, while the balls, due to their interaction with each other, the walls of the reactor housing 9 and the plates 7 of the reactor, are cleaned themselves and clean the structural elements of the reactor from the soot released from the gas. The soot, which is an anti-friction material, prevents wear on the ceramic balls. When using methane in the composition of gaseous hydrocarbons, the conversion of methane in the lower zone B of the reactor is no more than 5-20%.

Next, under the action of a backpressure from the gas to be processed and under the vacuum created in an upper chamber of the reactor by a compressor 16, the mixture of gases and the soot carried by the gas flow enter the upper zone A of the reactor, where the mixture is heated to a temperature of 800° C. to 1050° C. in 0.1-0.3 sec. The chain reaction of soot formation occurs exactly in this area, and the main conversion of methane is 80-90% due to the high rate of gas temperature change up to 300° C. in 0.1 sec.

Next, the mixture containing the hydrogen evolved during the conversion and the resulting excess soot enters a cyclone filter 12, where the soot and other solid particles, if any, are separated from the gas. The soot is removed from the cyclone filter by an inclined screw conveyor 18, and the soot may be cooled, during its removal, by using a heat exchanger arranged over the conveyor.

Next, the soot is removed from the process through a flood gate 24 into a hopper 20 for its subsequent packaging and sale.

The gas purified in the cyclone filter 12 and consisting of hydrogen and 7-10% methane is cooled in a plate gas-air cooler 13 to 250° C., whereupon the gas enters a gas-liquid cooler 14 and is cooled to a temperature of 20° C.-30° C. After that, it is purified in a fine filter 15 and, using a low-pressure compressor station 16, is supplied to a membrane station 17 for final hydrogen purification.

The compressor 16 controlled by an automation system automatically using the readings of a vacuum gauge 22 maintains a vacuum of 2 to 6 mbar, which compensates for the resistance of the cyclone filter 12, whereupon the reactor 25 operates at atmospheric pressure. The membrane station separates the gas released from the cyclone filter into 80-85% pure hydrogen and a 20-15% methane-hydrogen mixture. The methane-hydrogen mixture 30 is used as a fuel for the reactor 25 in the burner 23, and is also directed to the unit 2 and, mixed with the main gas, to the heater 4. The hydrogen purified by the membrane station 17 is stored in a gas holder 29 or is packed into cylinders.

The main feature of this method is an increase in the utilization of thermal energy and a hydrogen production from gaseous hydrocarbons without CO₂ emissions into the atmosphere. In this case, three processes constantly take place in one reactor housing, namely: high-speed ablative high-temperature pyrolysis, soot formation from saturated hydrocarbons, and soot removal from the reactor. The soot heated in the reactor to 850° C. serves as a catalyst and a filter for the resulting gas. To increase the ablative surface, the reactor housing is filled with the heat-resistant ceramic balls having a high thermal conductivity and heat capacity.

By using hydrogen-diluted methane in the burner of the reactor, CO₂ emissions are reduced during the heating of a hydrogen production reactor, for which reason the proposed method for hydrogen production is “blue” according to the EU classification. There are almost no CO₂ emissions, which amount to no more than 10% from the volume of hydrogen produced, while the hydrogen production by means of the “gray” hydrothermal cracking method leads to CO₂ emissions exceeding 100% of the volume of hydrogen produced. Furthermore, the cleaning of the entire ablation surface, including the balls, the reactor walls, the heating or heat-conducting elements, and the soot removal from the process are performed continuously. A controlled temperature difference up to 200° C., which is created in the reactor between the lower and upper zones, provides the chain reaction of carbon evolution. By preheating the gas with the waste flue gases, the gas consumption for heating the reactor and maintaining the process is reduced to 7-10% of the amount of the gas to be processed. The existing technologies for industrial hydrogen production by means of hydrocracking require up to 100% of gas to maintain the process.

The claimed technical result is achieved by implementing the high-speed high-temperature catalytic ablative pyrolysis, while ensuring gas destruction and the evolution of hydrogen and carbon in a vertical continuous reactor filled with the ceramic balls and a catalyst. At the same time, the soot formed during methane decomposition and heated to 850° C. is used as the catalyst. Given the size of the soot particles and the ceramic balls, an ablative surface area is many times larger than in the existing analogues. Another important feature of the invention is the creation of conditions for the chain reaction of solid carbon (soot) evolution by providing the controlled heating of the reactor housing in the lower part of the reactor to 750° C.-950° C. and in the upper part of the reactor to 950° C. —1150° C.

What is claimed is:

1. A method for the pyrolytic decomposition of hydrocarbons, comprising:
heating a pyrolysis reactor, which is arranged in a space bounded by a lining, by using flue gases generated by combusting a hydrogen-enriched mixture of air and gaseous hydrocarbons, while ensuring a maximum decrease in CO₂ emissions into an atmosphere;
moving the flue gases vertically downward in the space between the lining and the reactor;
supplying heated hydrocarbons to a lower part of the reactor; and
removing hydrogen and soot generated by the pyrolytic decomposition from an upper part of the reactor;
wherein the method further comprises:
increasing a heat transfer of the reactor from the flue gases to pyrolysis products using heat-conducting metal elements piercing through walls of the reactor;
forming a main ablation surface by filling an inner space of the reactor with ceramic balls inert to gaseous hydrocarbons and products of the pyrolytic decomposition of the gaseous hydrocarbons;
cleaning the heat-conducting elements and inner walls of the reactor from the soot due to multidirectional movements of the ceramic balls, by using blades fixed on a rotating shaft such that the ceramic balls move upward at a peripheral shell of the reactor and downward in a central part of the reactor near the rotating shaft;
maintaining a temperature in an upper zone of the reactor at a level of 950° C. to 1150° C.; and
heating a lower zone of the reactor such that the flue gases at an outlet of the reactor has a temperature in the range from 750° C. to 950° C. and preferably in the range of 700° C. to 800° C.

2. The method of claim 1, wherein hydrocarbon gases are used as the hydrocarbons.

3. The method of claim 2, wherein methane is used as the hydrocarbon gas.

4. The method of claim 1, wherein liquid heated hydrocarbons which are supplied under pressure through nozzles installed in the lower part of the reactor are used as the hydrocarbons.

5. The method of claim 4, wherein solid fusible hydrocarbons which are converted into liquid hydrocarbons by means of melting are used as the hydrocarbons.

6. The method of claim 1, wherein the mixture of air and hydrocarbon gas is enriched with hydrogen obtained by the pyrolytic decomposition of the hydrocarbons.

7. The method of claim 1, wherein the flue gases in the space between the lining and the reactor are moved from top to bottom, while providing the temperature in the lower part of the reactor in the range from 750° C. to 950° C. and ensuring a chain reaction of carbon evolution.

8. The method of claim 1, wherein the hydrocarbons are supplied to the reactor from bottom to top as a counter-flow to the flue gases, thereby ensuring uniform heating.

9. The method of claim 1, wherein liquid and gaseous hydrocarbons are heated to a temperature of 390° C. to 410° C. before the liquid and gaseous hydrocarbons are supplied to the reactor.

10. The method of claim 8, wherein fusible hydrocarbons are heated up to a temperature of 300° C. to 320° C.

11. The method of claim 2, wherein a flow rate of the hydrocarbon gases in the reactor is maintained such that a heating temperature of a gas flow in the reactor falls within the range from 700° C. to 1050° C., the gas temperature in the flow rising at a rate of up to 300° C. in 0.1 sec.

12. The method of claim 2, wherein a mixture of hydrogen with undecomposed hydrocarbon gases is removed from the upper part of the reactor, pure hydrogen is isolated from the mixture using a membrane filter, and one part of the mixture of hydrocarbon gases with hydrogen is directed to a burner to generate the flue gases, while another part of the mixture of hydrocarbon gases with hydrogen is re-directed to the reactor for the pyrolytic decomposition.

13. A unit for the pyrolytic decomposition of hydrocarbons, comprising:
a housing having a lining;
a vertical reactor installed in the housing and having walls provided with heat-conducting elements, the reactor having an inner space filled with ceramic balls inert to gaseous hydrocarbons and products of the pyrolytic decomposition of the gaseous hydrocarbons;
a vertical shaft having blades and installed in the reactor, the vertical shaft being rotatable, and the blades having a shape that ensures a movement of granules at an angle to a horizontal;
wherein:
an inlet manifold for supplying flue gases from a burner to the space between the reactor and the lining is arranged in an upper part of the reactor;
a manifold for removing waste flue gases from the reactor is arranged in a lower part of the reactor;
an inlet for supplying processed hydrocarbons is arranged in the lower part of the reactor;
a manifold for removing pyrolytic decomposition products from the inner space of the reactor is arranged in the upper part of the reactor,
the unit comprises a cyclone separator having an inlet connected to the upper manifold of the reactor and an outlet for purified gases connected to plate coolers and a filter-separator, the filter-separator having a gas outlet connected to a pump-compressor, the pump-compressor having an outlet connected to an inlet of a membrane filter, the cyclone separator being configured to separate a mixture of gases into pure hydrogen and a mixture of gases with hydrogen;
the membrane filter has an outlet that is intended for removing the mixture of gases with hydrogen and connected to the burner, the burner having a flue gas outlet connected to the inlet manifold for supplying the flue gases to the reactor; and
the cyclone separator has a conical part connected to a screw conveyor which removes soot deposited in the conical part into a hopper through a flood gate.

14. The unit of claim 13, wherein, when the unit is used for the pyrolytic decomposition of gaseous hydrocarbons, the inlet for supplying the heated processed gaseous hydrocarbons to the reactor is made as a manifold.

15. The unit of claim 13, wherein, when the unit is used for the pyrolytic decomposition of liquid hydrocarbons, the inlet for supplying the processed hydrocarbons is made as a nozzle unit.

16. The unit of claim 15, wherein, when the unit is used for the pyrolytic decomposition of solid fusible hydrocarbons, the unit further comprises a unit for melting the solid fusible hydrocarbons which is connected to a pump for supplying the molten hydrocarbons to nozzles.

17. The unit of claim 13, wherein the blades near the shaft and near the walls of the inner space of the reactor are made with an opposite pitch.

18. The unit of claim 13, wherein the heat-conducting elements pass through the walls of the reactor such that the same heat-conducting element is in contact with the flue gases in an outer part of the reactor and with the balls and the pyrolysis products in an inner part of the reactor.

19. The unit of claim 13, wherein the blades fixed on the rotating shaft have such a shape that causes the ceramic balls to move, thereby cleaning heat-conducting elements, the walls of the reactor and the balls themselves from the soot deposited thereon.
